(19) United States
(12) Patent Application Publication
(10) Pub. No.: US 2024/0419317 A1
(43) Pub. Date: Dec. 19, 2024

(54) GRAPHIC USER INTERFACE USING KINEMATIC INPUTS ON TRANSFORMABLE DISPLAY DEVICE

(71) Applicant: CUBIOS, INC., Key West, FL (US)

(72) Inventors: Ilya OSIPOV, Sarasota, FL (US); Savva OSIPOV, Sarasota, FL (US); Maxim FILIN, Sarasota, FL (US)

(21) Appl. No.: 18/270,331

(22) PCT Filed: Jan. 3, 2022
(86) PCT No.: PCT/US2022/011056

§ 371 Date: Jul. 1, 2024

Related U.S. Application Data
(60) Provisional application No. 63/187,737, filed on May 12, 2021.

(30) Foreign Application Priority Data
Dec. 31, 2020 (RU) 2020144399

(51) Int. Cl. G06F 3/0485; G06F 1/16

(52) U.S. Cl. CPC G06F 3/0485; G06F 1/1694; G06F 2200/1637

(57) ABSTRACT

An automated method for facilitating an interactive gaming environment in variable multi-display arrangement includes compiling or receiving at least two various subsets of images, assigning rules of interacting of elements belonging to different subsets of images, and deploying one or more modes of processing resulting images.

### PRIOR APPLICATIONS

This application claims priority to Russian Federation application Ser. No. 20/201,44399, filed Dec. 31, 2020, now Patent No. RU 2750848, and U.S. Provisional Application No. 63/187,737, filed May 12, 2021, the disclosures of which are incorporated by reference herein.

### BACKGROUND

Hand-held devices used for gaming, entertainment, communication and other applications employ kinematic inputs from various sensors built into the device to allow users control application content.

(1) Device linear acceleration, angular rotational velocity and/or orientation with respect to Earth's magnetic field sensed by means of at least one built-in device selected from the group of accelerometer, gyroscope and compass sensor: (2) user gestures sensed by means of touch-sensitive surfaces as haptic and/or tactile contact.

In particular, these inputs have been used to set displayed image view selection, orientation, selection of imaged area from stored image file. Kinetic inputs are used for setting equations of motion for certain objects or the frame for content scrolling. Kinematic inputs and preset rules have been used for setting the initial speed, friction terms and parameters for rubber-banding.

Transformable multi-screen device concept has been implemented in the foldable hand-held format. In some cases these devices have comprised sensors detecting relative positions of displays, their mutual connectedness, proximity, and orientation.

Recently, significant developments have happened in “Transreality Puzzles”, a subset of the Mixed Reality devices, whereby a user interacts with a transformable input device physically via positioning, slanting, or turning its elements, thus affecting events in virtual space, virtual objects being correlated to physical ones.

Virtual objects in transreality puzzles may be displayed on a separate display like a flat panel display or a wearable VR/AR set connected to the transformable input device experiencing mechanical inputs with a cable or wirelessly. In some configurations, virtual objects may be displayed and experience transformations on a display or a plurality of displays placed on the outside surfaces of the transformable input device itself.

### BRIEF DESCRIPTION OF THE DRAWINGS

FIG. 1 is a flow diagram illustrating operations for using kinetic inputs to control kinetic parameters of display content according to some embodiments.

FIG. 2A is a diagram illustrating a group of four electronic devices in a first position according to one aspect of the embodiments.

FIG. 2B is a diagram illustrating a group of the four electronic devices of IFG. 2A with the devices in a second position according to a related aspect of the embodiments.

FIG. 2C is a diagram illustrating adjacent electronic devices with connection to one another according to another aspect of the embodiments.

FIGS. 3-5 are diagrams illustrating a transformable device comprising 8 cubelets in which aspects of the embodiments may be implemented.

FIG. 6 is a block diagram illustrating a hardware platform on which aspects of the embodiments may be implemented.

FIG. 7 is a diagram illustrating operation of a device such as the device of FIGS. 3-5 according to some aspects of the embodiments.

FIG. 8 is a flow diagram illustrating additional operations in accordance with some embodiments.

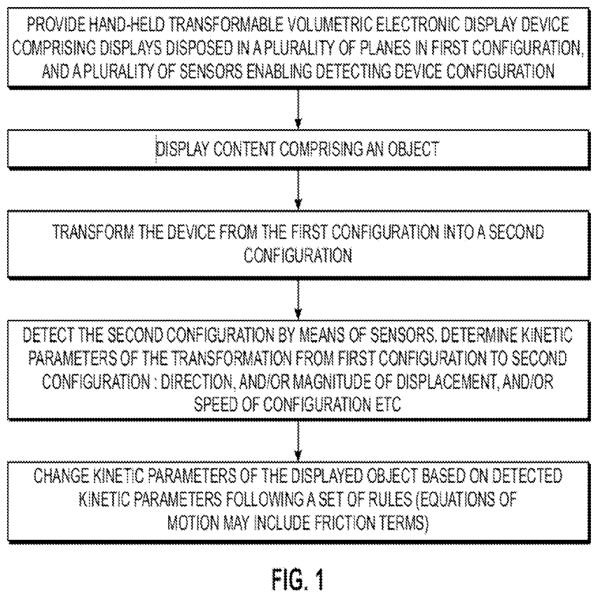

### DETAILED DESCRIPTION

The illustrations included herewith are not meant to be actual views of any particular systems, memory device, architecture, or process, but are merely idealized representations that are employed to describe embodiments herein. Elements and features common between figures may retain the same numerical designation except that, for ease of following the description, for the most part, reference numerals begin with the number of the drawing on which the elements are introduced or most fully described. In addition, the elements illustrated in the figures are schematic in nature, and many details regarding the physical layout and construction of a memory array and/or all steps necessary to access data may not be described as they would be understood by those of ordinary skill in the art.

We have disclosed the concept of volumetric transformable and emulated-transformable devices in U.S. Ser. No. 63/176,459; PCT/US17/57296; U.S. Ser. Nos. 63/173,085; 63/054,272; 62/925,732; 62/629,729; 62/462,715; 62/410,786; 29/765,598; 29/762,052; 29/703,346; 29/644,936; 29/601,560; 17/141,123; 17/078,322; 16/986,069; 16/537,549; 16/074,787; PCT/US2017/057296; PCT/RU2018/050016; PCT/RU2020/050168; U.S. Ser. Nos. 62/925,732; 62/629,729; 62/462,715; 62/410,786; 29/601,560 (Apr. 24, 2017), and related patent matters and non-patent publications which are incorporated hereby herein in their entirety.

### Hand Held Transformable Volumetric Electronic Display Device Adapted to Use Kinetic Inputs to Control Kinetic Parameters of Display Content

In some embodiments, hand-held electronic display device is a volumetric transformable device of a generally cubic shape configured as a 2×2×2 or a 3×3×3 cube. In some other embodiments, the hand-held electronic display device is an emulative-transformable volumetric device. In vet some other embodiments, the hand held electronic display devic is a volumetric device of a non-cubic shape, receiving user unputs though either transformative or emulated transformative action into visual user interface. Displays disposed in mutually non-parallel planes. True transfromable display (relative positions of electronic displays, or segments of emulated displays may be changed by user hand gesture or movemnet input).

### Example 1

### Tiled Transformable Display

A plurality of autonomous display devices is arranged as an array with individual devices immediately adjacent to or at a short distance from nearest neighbor. In some embodiments. They may be disposed along a line, or in a shape of a polygon, as a two dimensional array organized into rows and columns, hexagonally-shaped devices may be arranged into a honeycomb structure, or any number of other arrangements.

In some embodiments, the plurality of autonomous display devices (modules) may be arranged as a volumetric article, e.g. a 2×2×2 or 3×3×3 cubes.

Each of the modules comprises a display, a microprocessor, a power source. In some embodiments, each modules of the plurality comprises means for sensing spatial position and acceleration: gyroscopes and/or accelerometers, and/or contact groups and/or sensors for near-range data exchange and transmission. The means for near-range data exchange and transmission may be chosen from a group including, but not limited to, IR sensors, RFID, Hall-effect sensors. Some embodiments may comprise mid-range communication means akin to BlueTooth.

The modules were programmed to continuously survey their immediately adjacent module surfaces and map the total modular device configuration, thus registering device transformations in real time.

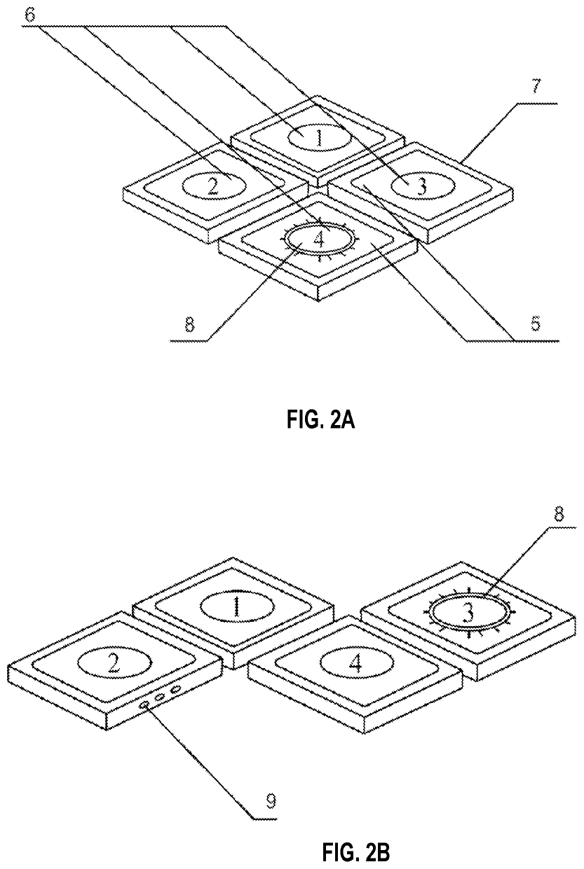

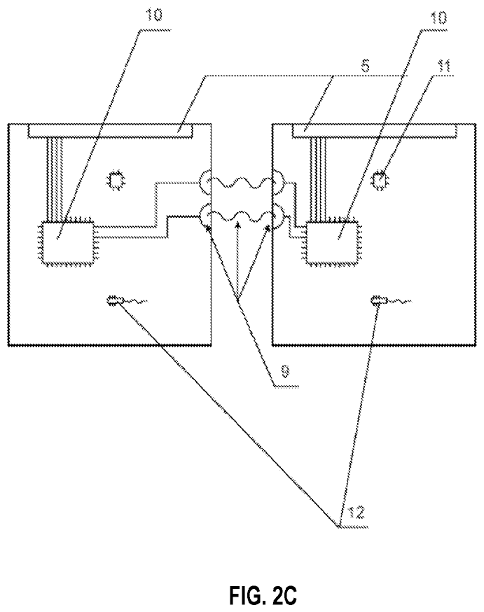

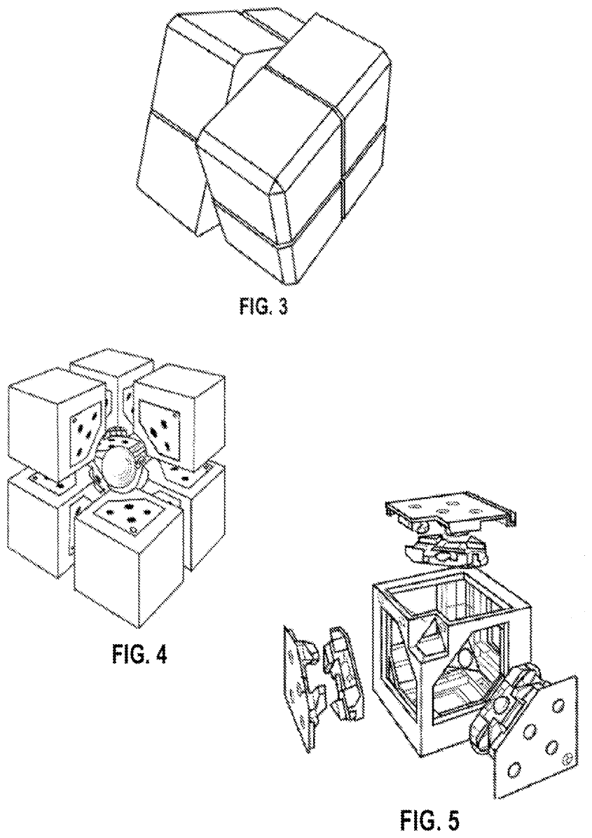

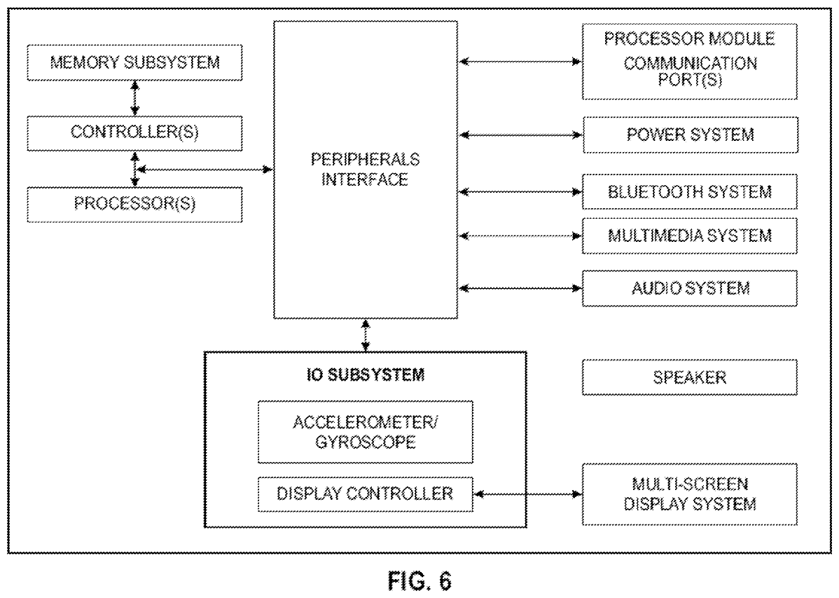

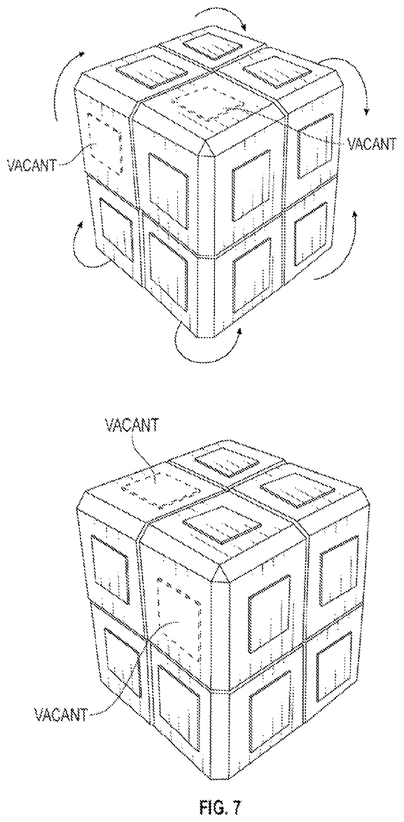

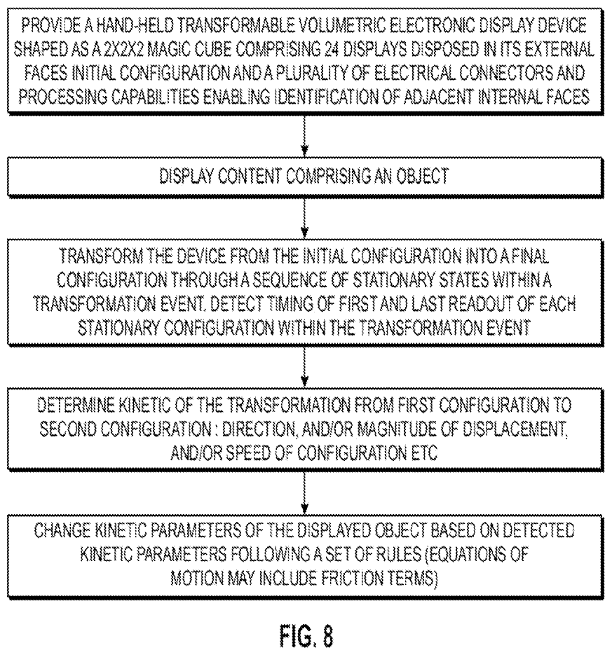

In FIGS. 2A-2C, which are described below, the following reference numerals are shown:
1—the first electronic device:
2—the second electronic device:
3—the third electronic device:
4—the fourth electronic device:
5—displays of electronic devices:
6—areas of location of graphic: elements, e.g. drawn menu items, icons, icons
7—enclosure electronic device:
8—a graphical element, a selector that is used to select and activate menu items:
9—contact group for data transfer between devices, connectors of wired or wireless data transmission:
10—microprocessor:
11—a sensor of the spatial position of an electronic device, for example, a gyroscope-accelerometer:
12 is a module for exchanging signals between electronic devices, for example, a wireless data transmission module, for example, a Bluetooth module.

According to FIGS. 2A-2C, the control of a group of electronic devices, each of which has at least one display 5 connected to a microprocessor 10 that is connected to a power source (not shown), with a signal exchange module 12 between electronic devices and with a spatial position sensor of the electronic device 11 occurs in such a way that from the initial position of the group shown in FIG. 2A, the electronic devices 3 and 4 move along electronic devices 1 and 2, in which the graphic element 8 continues its movement in the same direction and moves from the display of the electronic device 4 to the display of the electronic device 3 as shown in FIG. 2B. FIG. 2C shows a functional diagram of the connection of adjacent electronic devices.

FIG. 2A illustrates an embodiment wherein an interface comprises 4 identical display devices, each displaying at least a single menu item. A selector is shaped as a highlighted line or stripe, or some other intuitively clear way to highlight the selected menu item, in this example item displayed on module 4, the departure module.

A user provides input to the interface by moving the selector between the icons displayed on the adjacent modules, or within a single module wherein a plurality of icons is displayed on the same display through a number of means, including but not limited to:
(i) Slanting the device: the change m device orientation 1 s sensed by gyroscope(s)/accelerometer(s) built into the modules:
(ii) A “throw” gesture sensed by touch sensors, Fource-touch or a similar technology, or
(iii) change in relative position of the display.

Consider input through device transformation illustrated in FIGS. 2A-2B, wherein modules 3 and 4 are moved sliding relative to modules I and 2. This move may be viewed shifting two-module layer comprising modules 3 and 4 relative to a two-module layer comprising modules I and 2. The shit happens between stationary defined by immediate contact or proximity registered by connectors or sensors (e.g. RFID or infrared, or Hall-effect sensors) placed on side surfaces of the modules, see FIGS. 2B-2C.

The user input is registered by module 4 processor when its immediate neighbor ID readout changes from the adjacent surface of module 2 to adjacent surface of module 1. Each side surface fthe display modues is provided by a unique ID determined when a stationary configuration is established.

The user input is registered by module 4 is processed by its built-in processor, and the kinetic inputs are determined, comprising spatial and temporal characteristics of the input (slant, “throw” or modules relative position shift). The processing method comprises a rule for determining an equation of motion for the selector (the kinetic characteristics like direction, initial speed, deceleration etc). The equation of motion is communicated to the destination module 3.

In one embodiment the selector stopped being displayed on departure module 4, and synchronously started being displayed on destination module 3. The timing of this apparent “shift” is set for it to happen immediately after the new stationary configuration is established and identified through the communications protocol between the modules. This transition, manifesting as apparent moving of the selector from the menu item displayed on module 4 onto that on module 3. This apparent movement of selector in the direction defined by the user-initiated relative shift of modular layers is perceived by the user as akin to inertial motion of physical objects. In some embodiments, the selector was moved in the direction opposite to the shift of modules on which it was initially displayed: this created a different intuitively inertia-linked user perception.

In another embodiment, the selector was moved continuously from its central position on module 4 into its central position on module 3 across the border defined by adjacent sections of the respective display bezels and the gap between them.

In yet another embodiment, the continuous motion of the selector was implemented at a velocity correlated to the rate of transformation (inversely proportional to last readout in the departure stationary configuration and the first sensor readout in destination stationary configuration).

In a further embodiments, the continuous motion of the selector was configured using an equation of motion comprising a friction term, simulating selector deceleration as it was settling into its destination position on the menu item displayed on module 3.

In some further embodiments, the selector apparent movement was accompanied with animation effects and sound on display modules.

Activation of the menu item was implemented though a building-in, tap or push gesture detected with touch-screen or force-touch or a similar technology. The activation input is processed on the module where the input is received, and gets transmitted to the rest/adjacent modules in accordance with the application settings by means of connectors, radio or infrared inter-modular communication subsystem as described above.

Along with simple selection of menu items, pictograms, or icons, we implemented the display transformation, throw gestures and display slanting for ordering lists, shifting the menu items and other objects around the display surface. In these cases, rather than moving the selector, a menu item, a pictogram or a game object like sprite or game character was moved between the modules.

In some embodiments, the hand held device was controlled through a combination of slanting. transformation and gestures registered through touch screen or touch-force technology.

The resultant interactive input arrangements provided an intuitively clear graphic user interface (GUI) and perception of the transformable tiled display formed by the display modules as a unified display. Thus enhanced user experience was achieved.

### Example 2

### Volumetric Transformable Device Consists of 2×2×2 Modules

In one embodiment, a volumetric transformable device was composed of 8=2×2×2 identical modules of generally cubic shape. Each module was arranged as a fully functional display device, with three displays disposed in its three intersecting faces. Electrical magnetic connectors supporting power and signal interface with other modules were disposed on three other faces. The connectors also supported the integrity and transformability of the device.

The module outward arrangement of displays and connectors was fully three-fold symmetric with regard to rotation around its main diagonal. Each module comprised a memory subsystem, at least one controller, and at least one processor, interfaced
with communication ports, power system, Bluetooth system, multimedia system, audio system connected to a built-in speaker, input-output subsystem comprising orientation sensing subsystem and a display controller managing the multi-screen display system.

The orientation sensmg subsystem comprised a BMII 60 integrated inertial measurement unit from Bosch Sensortec providing precise linear acceleration (accelerometer) and angular acceleration (gyroscopic) measurements. Each module was provided with unique identifiers for its contact surfaces. Furthermore, the module firmware supports exchanging the identifiers between adjacent modules, thus identifying unambiguously each of the 24 internal faces presence, grouping and mutual orientation with its immediate adjacent face. Relative rotations of two 4-module layers by 90 degrees are basic transformations enabled by the device.

Each of the internal contact faces of the module was assigned unique identifier: overall the 24 internal faces has been indexed as or isomorphic to a two-dimensional array (Mn: n=1,2,3,4,5,6,7 or 8;Sk: k=1, 2 or 3) where in Mn identifies a module and Sk identifies one of its surfaces.

The processor built into each module executed, repetitively with set time interval, a survey of identifiers the unique IDs of adjacent surfaces, thus identifying for each of its own three internal faces an immediately adjacent cube and Any allowed stationary state of the cube could be described a table of general structure represented as 12 internal face-to-internal face combinations (Mn1:Sk1)*(Mn2:Sk2), where Mn1i:Mn2. The plurality of all accessible configurations constituted a transformation space of the cube.

Upon a series of rotations of the 4-module layers the device was transformed from its initial stationary configuration into its final stationary configuration. The series of rotations defined the transformation event comprising one or multiple basic transformations through a sequence of stationary configurations The timing of first and last readouts of all stationary configurations within a preset time window, defined a transformation event: the timed readouts of stationary configurations withing the transformation events were used used as kinetic inputs to determine kinetic parameters of the transformation.

In one embodiment, the displayed content was configured to support a version of a popular puzzle game 2048. One of the components of the game was centered around relative rotation of a four-module group in the direction of a vacant display-sized field. The device was adapted to detect rotation direction as illustrated, and, when the vacant field (no number image) was detected in the direction of rotation (“down-rotation” analogous to down-wind or down-stream) from an occupied field( ), the content of the filled field is moved at a constant screen-displacement velocity to the previously initially vacant field. As illustrated, numbers “four” (objects) are rotated into vacant fileds in the directions of detected relative rotations of the respective 4-module layers. The velocity of movement in the display plane or across an edge was set constant.

In another embodiment, the velocity of an object movement in display plane or across the plane was set proportional to the detected speed of transformation (inversely proportional to time between the last readout of initial stationary configuration and the first redout of the subsequent initial configuration.

In yet another embodiment, a friction term was implemented in the equation of object motion, to support apparent deceleration of the object as it was approaching its intended position, in the center of the target display tile.

In some embodiments, the kinetic action of the object triggered by the detected transformation of the hand-held device was counter-directed (counter) to the rotation of the four-module layer, or normal to it, or a combination of the kinetic action in the direction/counter to it, and a normal kinetic action.

### SUMMARY OF AN EMBODIMENT

a movable object (e.g.t selector) and a reference frame.
the reference frame is generally static.
the object is sensitive to scrolling using touch-sensor or/and transformation).
inertial motion simulated: object follows kinetic input i.e. it continues to move in/against/normal to/linear combination of the direction communicated by user: equation of motion may include deceleration term
user input through device transformation/gesture/orientation change.
object may pass from a display to an adjacent one and interact with the reference frame following a set of predetermined rules like: adding numbers, adding additional elements thus creating new gaming plots, fusing colors and causing sounds and musical effects.

### ADDITIONAL NOTES AND EXAMPLES

Example 1 is an automated method for facilitating an interactive gaming environment in variable multi-display arrangement, said method comprising: compiling or receiving at least two various subsets of images; assigning rules of interacting of elements belonging to different subsets of images; and deploying one or more modes of processing resulting images.

In Example 2, the subject matter of Example 1 includes, wherein the one or more subsets of images are originally defined as selectors and reference frames.

In Example 3, the subject matter of Examples 1-2 includes, wherein the subset of images defined as selectors are the subject for inertial interface.

In Example 4, the subject matter of Examples 1-3 includes, wherein the inertial interface assumes that scrolling initiated by user continues for the predetermined time interval after the instant when the original action of scrolling stopped.

In Example 5, the subject matter of Examples 1-4 includes, wherein the initial scrolling is initiated by touching the screen of one of displays of multi display system and continuous moving the touching point in the direction chosen by user.

In Example 6, the subject matter of Examples 1-5 includes, wherein the initial scrolling is initiated by the change of the entire multi display system orientation in space thus assuming that gravitation causes the motion of certain subsets of images.

In Example 7, the subject matter of Examples 1-6 includes, wherein the subset images chosen as selectors move in the direction of gravitation for the predetermined time intervals following the drastic change of the positions of multi display system initiated by user.

In Example 8, the subject matter of Examples 1-7 includes, wherein the subset images chosen as selectors move in the direction of initial scrolling initiated by the user for the predetermined time intervals.

In Example 9, the subject matter of Examples 1-8 includes, wherein the subset of images defined as reference frame is indifferent to the inertia, and it is not the subject for inertial interface, therefore their positions in each display of multi display environment do not change when position and orientation of the entire multi-display system is changed.

In Example 10, the subject matter of Examples 1-9 includes, wherein the subset of images defined as reference frame is indifferent to the inertia, and it is not the subject for inertial interface, therefore their positions in each display of multi display environment do not change when user initiated the scrolling of other subsets of images.

In Example 11, the subject matter of Examples 1-10 includes, wherein an entire system of images changes when some elements of selector subset collide with elements reference frame subset.

In Example 12, the subject matter of Examples 1-11 includes, wherein the number as elements of selector subset meet numbers as elements of reference frame subset and the sum of these numbers is indicated instead of initial numbers.

In Example 13, the subject matter of Examples 1-12 includes, wherein the color fields of the selector subset meet the color fields of reference frame subset and the colors fuse in a predetermined way.

In Example 14, the subject matter of Examples 1-13 includes, wherein images of the selector subset are added to the existing images of the reference frame subsets thus creating a different total image and a different game plot in each particular display of multi display environment and in the whole multi display system.

In Example 15, the subject matter of Examples 1-14 includes, the system comprising interconnected multi displays located both in the same plane and in different planes that are intersecting and parallel.

In Example 16, the subject matter of Example 15 includes, wherein the selector subset of images following inertial scrolling passes between neighboring displays located in the same plane conserving both the projection of the velocity on the border line of neighboring displays and the projection of the velocity normal to this line.

In Example 17, the subject matter of Examples 15-16 includes, wherein the selector subset of images following inertial scrolling passes between neighboring displays located in intersecting planes conserving both the projection of the velocity on the border line of neighboring displays and the projection of the velocity normal to this line.

In Example 18, the subject matter of Examples 15-17 includes, wherein a configuration of various displays is changeable by the user via a user interface, such that the configuration becomes variable and a neighboring display can be changed with time.

In Example 19, the subject matter of Examples 15-18 includes, wherein the selector subset of images following inertial interface passes between displays that are the neighbors at that instant when the particular element of image hits the border line between displays.

Example 20 is at least one machine-readable medium including instructions that, when executed by processing circuitry, cause the processing circuitry to perform operations to implement of any of Examples 1-15.

Example 21 is an apparatus comprising means to implement of any of Examples 1-19.

### CONCLUSION

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalents.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as will be understood by persons of ordinary skill in the art.

Any incorporation by reference of documents above is limited such that no subject matter is incorporated that is contrary to the explicit disclosure herein. Any incorporation by reference of documents above is further limited such that no claims that are included in the documents are incorporated by reference into the claims of the present Application. The claims of any of the documents are, however, incorporated as part of the disclosure herein, unless specifically excluded. Any incorporation by reference of documents above is yet further limited such that any definitions provided in the documents are not incorporated by reference herein unless expressly included herein.

For purposes of interpreting the claims for the present invention, it is expressly intended that the provisions of Section 112 (f) of 35 U.S.C. are not to be invoked unless the specific terms “means for” or “step for” are recited in a claim.

1. An automated method for facilitating an interactive gaming environment in variable multi-display arrangement, said method comprising:
compiling or receiving at least two various subsets of images;
assigning rules of interacting of elements belonging to different subsets of images; and
deploying one or more modes of processing resulting images.

2. The method of claim 1, wherein the one or more subsets of images are originally defined as selectors and reference frames.

3. The method of claim 2, wherein the subset of images defined as selectors are subject to inertial interface.

4. The method of claim 3, wherein the inertial interface causes scrolling which is to be initiated in response to an original action of a user via a user interface, continues for a predetermined time interval after an instant when the original action of scrolling has stopped.

5. The method of claim 4, wherein the initial scrolling is initiated by touching the screen of one of the displays of the multi display system and continuous moving a touching point in a direction chosen by a user.

6. The method of claim 4, wherein the scrolling is initiated by a change of the entire multi display system orientation in space based on gravitation causing motion of certain subsets of images.

7. The method of claim 4, wherein the subset of images defined as selectors move in a direction of gravitation for the predetermined time intervals following a drastic change of the positions of multi display system initiated by the user.

8. The method of claim 4, wherein the subset of images defined as selectors move in a direction of initial scrolling initiated by the user for the predetermined time intervals.

9. The method of claim 3, wherein the subset of images defined as the reference frames is indifferent to any inertia, and it is not subject to inertial interface, whereby their positions in each display of the multi display environment do not change when position and orientation of the entire multi-display system is changed.

10. The method of claim 3, wherein the subset of images defined as the reference frames is indifferent to the inertia, and not subject to inertial interface, whereby their positions in each display of the multi display environment do not change in response to user initiated scrolling of other subsets of images.

11. The method of claim 2, wherein a system of images changes when some elements of the selector subset collide with elements of the reference frame subset.

12. The method of claim 2, wherein a numerical representation of elements of the selector subset meet numerical representations of elements of the reference frame subset and a sum of these numbers is indicated instead of initial numbers.

13. The method of claim 2, wherein color fields of the selector subset meet color fields of the reference frame subset and the colors fuse in a predetermined way.

14. The method of claim 2, wherein images of the selector subset are added to the existing images of the reference frame subsets thus creating a different total image and a different game plot in each particular display of multi display environment and in the whole multi display system.

15. A system comprising:
a multi-screen display system including a plurality of interconnected displays situated both in the same plane and in different planes that are intersecting and parallel:
at least one microprocessor associated with a corresponding at least one of the displays; and
a spatial-position sensor associated with a corresponding at least one of the displays:
wherein the at least one microprocessor is operative to perform:
compiling or receiving at least two various subsets of images;
assigning rules of interacting of elements belonging to different subsets of images; and
deploying one or more modes of processing resulting images;
wherein in the one or more modes, the one or more subsets of images are originally defined as selectors and reference frames; and
wherein the subset of images defined as selectors are subject to an inertial interface that causes scrolling initiated by a user, via an original action, to be continued for a predetermined time interval after an instant when the original action of scrolling has stopped.

16. The system of claim 15, wherein the subset of images defined as selectors following inertial scrolling passes between neighboring displays located in the same plane conserving both the projection of a velocity on a border line of neighboring displays and a projection of the velocity normal to this line.

17. The system of claim 16, wherein the subset of images defined as selectors following inertial scrolling passes between neighboring displays located in intersecting planes conserving both the projection of the velocity on the border line of neighboring displays and the projection of the velocity normal to this line.

18. The system of claim 15, wherein a configuration of various displays is changeable by a user via a user interface, such that the configuration becomes variable and a neighboring display are changed with time.

19. The system of claim 15, wherein the subset of images defined as selectors following inertial interface passes between displays that are neighbors at that instant when the particular element of image hits the border line between displays.
